(19) United States
(12) Patent Application Publication
(10) Pub. No.: US 2026/0217266 A1
(43) Pub. Date: Jul. 30, 2026

(54) IN-VEHICLE DEVICE

(71) Applicants: TOYOTA JIDOSHA KABUSHIKI KAISHA, Toyota-shi (JP); DENSO TEN Limited, Kobe (JP)

(72) Inventors: Zhenqin Shi, Tokyo (JP); Akira Toyota, Kobe (JP); Ryosuke Matsuoka, Kobe (JP); Koichiro Takeuchi, Nagoya-shi (JP)

(73) Assignees: TOYOTA JIDOSHA KABUSHIKI KAISHA, Toyota-shi (JP); DENSO TEN Limited, Kobe (JP)

(21) Appl. No.: 19/435,947

(22) Filed: Dec. 30, 2025

(30) Foreign Application Priority Data
Jan. 24, 2025 (JP) 2025-010940

(51) Int. Cl. B60W 50/08; B60K 35/10; G05D 1/227; G05D 1/80; B60W 50/00

(52) U.S. Cl. CPC B60W 50/08; B60K 35/10; G05D 1/227; G05D 1/80; B60W 2050/0063

(57) ABSTRACT

An in-vehicle device that is installed in a vehicle includes a communication unit that communicates with a server device, an input unit that accepts an operation of a user, and a control unit that performs setting in accordance with a latter instruction, out of a first instruction by operating the input unit for setting an operation of the vehicle and a second instruction from the server device, in which, when an earlier instruction out of the first instruction and the second instruction indicates authority over the vehicle, the control unit performs setting in accordance with the earlier instruction.

### CROSS-REFERENCE TO RELATED APPLICATION

This application claims priority to Japanese Patent Application No. 2025-010940 filed on January 24, 2025. The disclosure of the above-identified application, including the specification, drawings, and claims, is incorporated by reference herein in its entirety.

### BACKGROUND

### 1. Technical Field

The present disclosure relates to an in-vehicle device.

### 2. Description of Related Art

There is known technology for circumventing control conflict caused by a plurality of instructions given to a vehicle overlapping. For example, Japanese Patent No. 6837508 discloses technology for circumventing control conflict based on communicable distance in a communication standard when a vehicle and a terminal device communicate with each other.

### SUMMARY

There is room for improvement in accuracy of settings regarding vehicle operations.

An in-vehicle device and so forth that can improve accuracy of settings for vehicle operation is disclosed below.

An in-vehicle device according to an embodiment of the present disclosure is an in-vehicle device that is installed in a vehicle, and includes a communication unit that communicates with a server device, an input unit that accepts an operation of a user, and a control unit that performs setting in accordance with a latter instruction, out of a first instruction by operating the input unit for setting an operation of the vehicle and a second instruction from the server device, in which, when an earlier instruction out of the first instruction and the second instruction indicates authority over the vehicle, the control unit performs setting in accordance with the earlier instruction.

According to the in-vehicle device and the like of the present disclosure, accuracy of settings for vehicle operation can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a control system; and

FIG. 2 is a flowchart showing operations of an in-vehicle device.

### DETAILED DESCRIPTION OF EMBODIMENTS

An embodiment of the present disclosure will be described below.

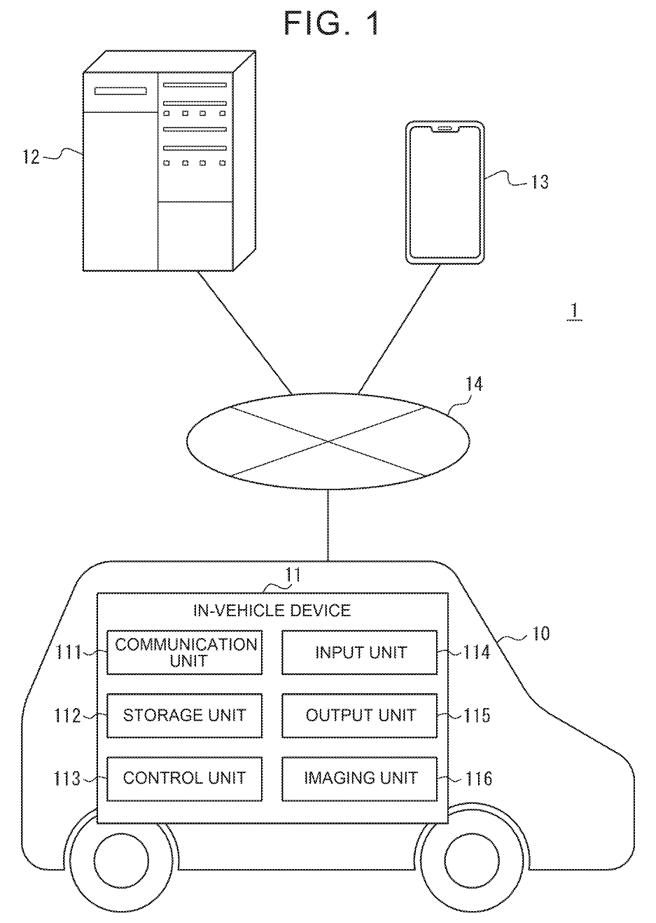

FIG. 1 is a diagram illustrating an overview of a control system according to an embodiment. A control system 1 includes an in-vehicle device 11 installed in each of one or more vehicles 10, one or more server devices 12, and one or more terminal devices 13. The vehicle 10 is, for example, a passenger automobile, a commercial vehicle, or the like. The in-vehicle device 11 is an information processing device that controls the vehicle, such as for example, an electronic control unit (ECU) or the like. The server device 12 is, for example, a server computer belonging to a cloud computing system or some other computing system and functioning as a server implemented with various functions. The server device 12 is, for example, a server provided by a business that operates the control system 1. The terminal device 13 is, for example, a personal computer or a tablet terminal device, and is used by a user of the vehicle 10. The network 14 is, for example, the Internet, a wide area network, or the like. The in-vehicle device 11 and the server device 12, and the server device 12 and the terminal device 13, are each connected via the network 14 so as to be capable of communicating with each other.

The in-vehicle device 11 according to the present embodiment performs settings for operation of the vehicle 10. Operations to be set include overall operations of each of units making up the vehicle 10, such as operations of, for example, a drive recorder device, an automotive navigation system, a driver-assistance system, an air conditioning, and so forth. Settings for the drive recorder device include setting sensitivity of an impact detection function to one of a plurality of stages, such as for example, "high, medium, and low", and performing startup or stopping a continuous recording function and an audio recording function of a camera. Setting of operations includes modifying existing settings.

The in-vehicle device 11 includes a communication unit 111 that communicates with the server device 12 and an input unit 114 that accepts user operations. A control unit 113 of the in-vehicle device 11 performs settings in accordance with a latter instruction from among setting instructions given by operating the input unit 114 (hereinafter, for convenience, referred to as "direct instructions") and setting instructions from the server device 12 (hereinafter, for convenience, referred to as "remote instructions"). When the user operates the terminal device 13 via an application or the like, a remote instruction is sent from the terminal device 13 to the server device 12 in response to the operation, and then sent from the server device 12 to the in-vehicle device 11. That is to say, instructions from the user are sent to the in-vehicle device 11 via the server device 12. Further, when an earlier instruction of the direct instruction and the remote instruction indicates authority over the vehicle 10 (hereinafter, for convenience, referred to as "usage authority"), the control unit 113 performs settings in accordance with the earlier instruction.

According to the present embodiment, a certain amount of time is required for the in-vehicle device 11 to receive a remote instruction via the server device 12, and a conflict can arise between the remote instruction and a direct instruction given by operating the in-vehicle device 11, but the conflict can be circumvented by deciding an appropriate instruction from among a plurality of the instructions in accordance with an order of the instructions and the usage authority. Now, the usage authority is authority to use the vehicle 10, and the usage of the vehicle 10 includes setting the operation of the vehicle 10. A person who has usage authority (hereinafter, for convenience, referred to as "authorized user") is, for example, an owner of the vehicle 10, a manager authorized by the owner, or the like. For example, an owner of the vehicle 10 that is the authorized user can permit a plurality of users, including family members and renters of the vehicle 10, to use the vehicle 10. Circumventing conflicts between multiple instructions from multiple authorized users improves accuracy of settings for vehicle operation.

As illustrated in FIG. 1, the in-vehicle device 11 includes a storage unit 112, an output unit 115, and an imaging unit 116, in addition to the communication unit 111, the control unit 113, and the input unit 114.

The communication unit 111 includes a mobile communication module compatible with mobile communication standards such as Long Term Evolution (LTE), 4th generation (4G), 5th generation (5G), or the like, a communication module compatible with wireless LAN standards, a short-range wireless communication module, and the like. The communication unit 111 connects to the network 14 and communicates with the server device 12.

The storage unit 112 includes one or more memory devices. The memory devices may be, for example, semiconductor memory, magnetic memory, optical memory, or the like. Each of the memory devices included in the storage unit 112 functions as, for example, a main storage device, an auxiliary storage device, or cache memory. The storage unit 112 stores information to be used for operations of the in-vehicle device 11, and information obtained by the operations of the in-vehicle device 11. The storage unit 112 may store, for example, information regarding settings of operation of the vehicle 10, an application program for accepting operations related to setting instructions, and identification information of the authorized user of the vehicle 10.

The control unit 113 includes one or more processors, one or more programmable circuits, one or more dedicated circuits, or a combination thereof. The processor is, for example, a general-purpose processor such as a central processing unit (CPU), a graphics processing unit (GPU), or the like, or a dedicated processor specialized for specific processing. The programmable circuit is, for example, a field-programmable gate array (FPGA). The dedicated circuit is, for example, an application-specific integrated circuit (ASIC). The control unit 113 controls each of the units of the in-vehicle device 11 and also controls overall operations of the in-vehicle device 11. The control unit 113, for example, sets the operation of the vehicle 10, and determines the order of instructions and instructions indicating usage authority.

The input unit 114 includes one or more input devices that accept operations by an operator. The input device is, for example, physical keys, capacitive keys, a capacitive panel, a touchscreen that is integrally provided with a display, a microphone that accepts speech input, or the like. The input unit 114 accepts input of information used in operations of the control unit 113, and sends the information that is input to the control unit 113. The input unit 114 accepts, for example, operations for setting the operation of the vehicle 10, and input operations for identification information and so forth of the operator.

The output unit 115 includes one or more output devices that output information. The output device is, for example, a display that outputs information as video, or a speaker or the like that outputs information as audio. The output unit 115 outputs the information that is obtained through operations of the control unit 113. The output unit 115 outputs, for example, images, audio, and so forth, related to instructions for setting the operation of the vehicle 10.

The imaging unit 116 includes a camera for capturing visible light images. For example, the imaging unit 116 captures an image of the operator of the in-vehicle device 11 and transmits the captured image to the control unit 113. The image includes a still image or a moving image. The imaging unit 116 may be provided outside the in-vehicle device 11 and connected to the in-vehicle device 11 via cable or wirelessly so as to be capable of exchanging control signals, images, and the like.

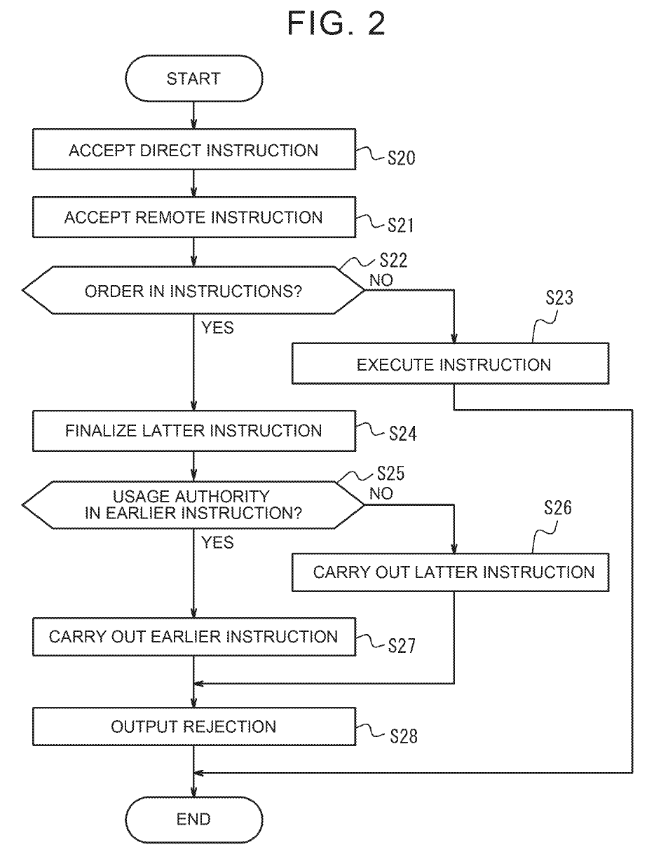

FIG. 2 shows an example of operations carried out by the control unit 113 of the in-vehicle device 11.

In S20, the control unit 113 accepts a direct instruction for operations of the vehicle 10 from the user. At this time, the control unit 113 adds a timestamp to the direct instruction, based on a clock function. That is to say, the timestamp corresponds to the point in time at which the direct instruction was input to the in-vehicle device 11 via the input unit 114. Also, the control unit 113 acquires one or more pieces of identification information corresponding to the direct instruction. The identification information corresponding to the direct instruction is information for identifying the authorized user, and is used to determine whether the operator sending the direct instruction is the authorized user. The identification information may be, for example, a user ID, biometric authentication information, or a digital key for the vehicle 10. The biometric authentication information is any biometric information of the authorized user, such as facial information, fingerprints, or the like. The digital key is information stored in the terminal device 13, which is, for example, a smartphone, and is used to unlock and to lock the vehicle 10. The user ID is acquired, for example, by being input via the input unit 114 along with a password, when the operator logs in to an application for giving direct instructions. The biometric authentication information is acquired, for example, by capturing an image of the operator using the imaging unit 116 of the in-vehicle device 11 or by detecting a fingerprint of the operator using a fingerprint sensor, or the like. The digital key is acquired, for example, by being sent from the terminal device 13 carried by the operator, to the in-vehicle device 11, using any wireless communication standard.

In S21, the control unit 113 receives a remote instruction from the terminal device 13 via the communication unit 111 and the server device 12. A timestamp is added to the remote instruction, based on a clock function of the terminal device 13. The timestamp corresponds to the point in time at which the terminal device 13 sends the remote instruction to the server device 12. Further, the control unit 113 acquires the remote instruction along with the identification information corresponding to the remote instruction. The identification information corresponding to the remote instruction is information for identifying the authorized user, such as a user ID or biometric authentication information, for example. The user ID is acquired at the terminal device 13 when the operator of the terminal device 13 logs in to an application for operating the remote instructions. The biometric authentication information is acquired, for example, by the terminal device 13 capturing a facial image of the operator of the terminal device 13, or by detecting a fingerprint of the operator, or the like.

When no direct instruction is given at the in-vehicle device 11, step S20 is omitted, and when no remote instruction is given at the terminal device 13, step S21 is omitted. Also, the remote instruction may be sent from a plurality of the terminal devices 13, in which case, step S21 is carried out for each terminal device 13. S20 may be inserted between any one or more of steps S21, or may be performed after step S21.

In S22, the control unit 113 determines whether there is an order of instructions, at every predetermined period. The predetermined period is, for example, any amount of time ranging from several tens of milliseconds to several seconds. The control unit 113 determines the order of the instructions by using the timestamps attached to each of the instructions received within the predetermined period. The instructions include one or more direct instructions given by operating the in-vehicle device 11, and one or more of the remote instructions sent from one or more terminal devices 13 via the server device 12. Even when it takes time for the control unit 113 to receive a remote instruction via the server device 12 due to communication delays and so forth, and the remote instruction conflicts with a direct instruction within a predetermined period, the order of the instructions can be determined based on the chronological order at the point in time the change of settings was instructed. When there is no order in instructions (No in step S22), that is to say, when only a direct instruction or a remote instruction has been accepted, in step S23 the control unit 113 carries out the direct instruction or remote instruction that is accepted. When there is an order in instructions (Yes in step S22), the in-vehicle device 11 finalizes the order of instructions in step S24.

In S25, the control unit 113 determines whether an earlier instruction finalized in step S24 indicates authority over vehicle 10, that is to say, usage authority. The control unit 113 determines whether the instruction indicates a usage authority based on either or both of identification information associated with a direct instruction or a remote instruction, and schedule information corresponding to the usage authority. The authorized user of the vehicle 10 registers one or more pieces of identification information in either or both of the storage unit 112 of the in-vehicle device 11 and the server device 12, when acquiring the usage authority, such as, for example, when performing purchasing, renting, or the like, of the vehicle 10. The authorized user, for example, operates the in-vehicle device 11 to input the identification information, sends the identification information to the server device 12 using the terminal device 13, or the like, thereby registering the identification information. The authorized user also acquires a digital key when, for example, performing purchasing, renting, or the like, of the vehicle 10. The control unit 113 reads out the identification information of the authorized user from the storage unit 112, and performs comparison thereof with the identification information acquired in step S20 or S21 to determine whether the instruction indicates usage authority. Also, the control unit 113 acquires the schedule information of the authorized user that is stored in advance in either or both of the server device 12 and the terminal device 13, and determines whether the instruction is from the authorized user, based on the schedule at the time the instruction was given. For example, when there is a schedule for driving the vehicle 10 (e.g., schedule for relocation) for when the instruction is given, determination is made that usage authority has been granted, and when there is a schedule for which there is a high likelihood that the vehicle 10 will not be driven (e.g., a work schedule), determination is made that no usage authority has been granted.

When determining that the earlier instruction does not correspond to the usage authority (No in step S25), the control unit 113 performs settings in step S26 in accordance with the latter instruction, and advances to step S28. When determining that the earlier instruction corresponds to the usage authority (Yes in step S25), the control unit 113 performs settings in accordance with the earlier instruction, i.e., the instruction corresponding to the usage authority in step S27, and advances to step S28.

In S28, the in-vehicle device 11 causes the in-vehicle device 11 or the terminal device 13 to output the instruction that was not executed in step S26 or step S27 (hereinafter, referred to as "rejected instruction"). For example, when the rejected instruction is a direct instruction accepted by the in-vehicle device 11, the control unit 113 causes the output unit 115 to output in step S28 that the direct instruction has been rejected. On the other hand, when the rejected instruction is a remote instruction accepted by the terminal device 13, the control unit 113 sends a notification rejecting the remote instruction (hereinafter referred to as a "rejection notification") to the server device 12 via the communication unit 111. The server device 12 sends a rejection notification to the terminal device 13 that sent the rejected instruction, from among the one or more terminal devices 13. The terminal device 13 performs output indicating that the remote instruction has been rejected.

Note that after step S26 or step S27, upon completing the setting in accordance with the instruction, the in-vehicle device 11 may cause the in-vehicle device 11 or the terminal device 13 to perform output indicating that the instruction has been completed.

Also, when determining whether an instruction indicates usage authority, different conditions may be used for direct instructions and remote instructions for the determination.

In a modification, determination of whether the remote instruction indicates usage authority may be made by the server device 12. At this time, the server device 12 acquires the identification information and schedule information of the authorized user from a storage unit of the server device 12 or the terminal device 13, and thereby determines whether the instruction corresponds to the usage authority. Instead of receiving the identification information in step S21, the control unit 113 receives results of determination of the usage authority from the server device 12 via the communication unit 111, along with the remote instruction and the timestamp.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions and so forth included in the configurations, steps, and so forth, can be rearranged such that no logical inconsistency arises, and a plurality of configurations, steps, and so forth can be combined into one or divided.

Also, an embodiment may be made in which, for example, a general-purpose computer functions as the in-vehicle device 11 according to the above embodiment. Specifically, a program describing processing contents for realizing each of the functions of the in-vehicle device 11 according to the above embodiment is stored in the memory of the general-purpose computer, and the program is read and executed by the processor. Accordingly, the present disclosure can also be realized as a program that can be executed by the processor or a non-transitory computer-readable medium that stores the program.

What is claimed is:

1. An in-vehicle device that is installed in a vehicle, the in-vehicle device comprising:
a communication unit that communicates with a server device;
an input unit that accepts an operation of a user; and
a control unit that performs setting in accordance with a latter instruction, out of a first instruction by operating the input unit for setting an operation of the vehicle and a second instruction from the server device, wherein
when an earlier instruction out of the first instruction and the second instruction indicates authority over the vehicle, the control unit performs setting in accordance with the earlier instruction.

2. The in-vehicle device according to claim 1, wherein the control unit determines an order of the first instruction and the second instruction, using a timestamp corresponding to a point in time at which the first instruction is input, and a timestamp corresponding to a point in time at which the second instruction is sent to the server device.

3. The in-vehicle device according to claim 1, wherein the authority is determined based on one or both of identification information associated with the first instruction or the second instruction, and schedule information corresponding to the authority.

4. The in-vehicle device according to claim 1, wherein the control unit receives a determination result regarding the authority from the server device.
